(19) United States
(12) Patent Application Publication
(10) Pub. No.: US 2024/0217396 A1
(43) Pub. Date: Jul. 4, 2024

(54) Apparatus And Method Of Controlling Seat Of Vehicle

(71) Applicants: Hyundai Motor Company, Seoul (KR); Kia Corporation, Seoul (KR)

(72) Inventors: KugHun Han, Seoul (KR); Seunghyun Kim, Daejeon (KR); Donghoon Lee, Seoul (KR); Munseung Kang, Suwon-si (KR); Yohan Kim, Ansan-si (KR); Minju Lee, Hwaseong-Si (KR)

(21) Appl. No.: 18/240,145

(22) Filed: Aug. 30, 2023

(30) Foreign Application Priority Data
Dec. 30, 2022 (KR) 10-2022-0190052

(51) Int. Cl. B60N 2/02

(52) U.S. Cl. CPC B60N 2/0229; B60N 2/0279

(57) ABSTRACT

A seat control apparatus is provided. The seat control apparatus may include: one or more processors, and memory storing instructions that, when executed by the one or more processors, cause the seat control apparatus to detect a collision of a vehicle, output, based on the detection, a collision occurrence signal; determine a seat operation mode of the vehicle between an automatic mode and a manual mode, output, based on the determination, one of an automatic mode seat operation request command or a manual mode seat operation request command, determine, based on the collision occurrence signal, whether to transmit one of the automatic mode seat operation request command or the manual mode seat operation request command; and drive, based on the one of the automatic mode seat operation request command or the manual mode seat operation request command, one or more seat motors to control a seat of the vehicle.

### CROSS-REFERENCE TO RELATED APPLICATION

This application claims priority to and the benefit of Korean Patent Application No. 10-2022-0190052 filed in the Korean Intellectual Property Office on Dec. 30, 2022, the entire contents of which are incorporated herein by reference.

### TECHNICAL FIELD

The present disclosure relates to an apparatus and a method of controlling a seat of a vehicle.

### BACKGROUND

One-touch walk-in is a function that allows a vehicle occupant to easily fold or unfold a seat. One-touch walk-in may be implemented as a button located at an upper portion, a lower portion, or a side of a seat. In addition to one-touch walk-in, a variety of functions using one-touch are being added, such as moving the seat to provide a comfortable position to an occupant, or giving the occupant a massage if the vehicle occupant presses a button. The one-touch function is distinct from manual control, which only operates the seat while the button is pressed, in that once the button is recognized as being pressed, the predetermined seat operation is completed regardless of whether the button is still pressed. For example, the one-touch function maximizes the convenience for the occupant, but if the button is unintentionally pressed, it is difficult to stop the operation which the occupant does not desire. In particular, if a button with a one-touch function is placed on the seat cushion, there may be insufficient clearance between the seat cushion and the door, and deformation in the event of an accident may cause the button to be pressed unintentionally, resulting in unwanted or unexpected seat operation.

### SUMMARY

According to the present disclosure, a seat control apparatus may comprise: one or more processors; and memory storing instructions that, when executed by the one or more processors, cause the seat control apparatus to: detect a collision of a vehicle; output, based on the detection, a collision occurrence signal; determine a seat operation mode of the vehicle between an automatic mode and a manual mode; output, based on the determination, one of an automatic mode seat operation request command or a manual mode seat operation request command; determine, based on the collision occurrence signal, whether to transmit one of the automatic mode seat operation request command or the manual mode seat operation request command; and drive, based on the one of the automatic mode seat operation request command or the manual mode seat operation request command, one or more seat motors to control a seat of the vehicle.

The instructions, when executed by the one or more processors, further may cause the seat control apparatus to deactivate, based on the collision occurrence signal, transmission of the automatic mode seat operation request command. The instructions, when executed by the one or more processors, further may cause the seat control apparatus to activate, based on a termination of the collision occurrence signal, transmission of the automatic mode seat operation request command.

The instructions, when executed by the one or more processors, further may cause the seat control apparatus to: determine, based on the automatic mode seat operation request command, whether an automatic mode operation condition is satisfied; and based on a determination that the automatic mode operation condition is satisfied, drive the one or more seat motors to control the seat. The instructions, when executed by the one or more processors, further may cause the seat control apparatus not to drive, based on a determination that the automatic mode operation condition is not satisfied, the one or more seat motors.

The instructions, when executed by the one or more processors, further may cause the seat control apparatus to transmit the manual mode seat operation request command regardless of whether the collision occurrence signal is outputted. The instructions, when executed by the one or more processors, further may cause the seat control apparatus to: determine, based on the manual mode seat operation request command, whether a manual mode operation condition is satisfied; and based on a determination that the manual mode operation condition is satisfied, drive the one or more seat motors to control the seat. The instructions, when executed by the one or more processors, further may cause the seat control apparatus not to drive, based on a determination that the manual mode operation condition is not satisfied, the one or more seat motors.

According to the present disclosure, a seat control apparatus may comprise: one or more processors; and memory storing instructions that, when executed by the one or more processors, cause the seat control apparatus to: detect a collision of a vehicle; output, based on the detection, a collision occurrence signal; determine a seat operation mode of the vehicle between an automatic mode and a manual mode; output one of an automatic mode seat operation request command or a manual mode seat operation request command; and determine, based on the collision occurrence signal and the one of the automatic mode seat operation request command or the manual mode seat operation request command, whether to drive one or more seat motors. The instructions, when executed by the one or more processors, further may cause the seat control apparatus to deactivate, based on the automatic mode seat operation request command and the collision occurrence signal, driving of the one or more seat motors.

The instructions, when executed by the one or more processors, further may cause the seat control apparatus to activate, based on the automatic mode seat operation request command and a termination of the collision occurrence signal, driving of the one or more seat motors. The instructions, when executed by the one or more processors, further may cause the seat control apparatus to: determine, based on the automatic mode seat operation request command, whether an automatic mode operation condition is satisfied; and based on a determination that the automatic mode operation condition is satisfied, drive the one or more seat motors to control a seat of the vehicle.

The instructions, when executed by the one or more processors, further may cause the seat control apparatus not to drive, based on a determination that the automatic mode operation condition is not satisfied, the one or more seat motors. The instructions, when executed by the one or more processors, further may cause the seat control apparatus to drive, based on the manual mode seat operation request command, the one or more seat motors to control a seat of the vehicle regardless of whether the collision occurrence signal has been received.

The instructions, when executed by the one or more processors, further may cause the seat control apparatus to: determine, based on the manual mode seat operation request command, whether a manual mode operation condition is satisfied; and based on a determination that the manual mode operation condition is satisfied, drive the one or more seat motors to control the seat of the vehicle. The instructions, when executed by the one or more processors, further may cause the seat control apparatus not to drive, based on a determination that the manual mode operation condition is not satisfied, the one or more seat motors.

According to the present disclosure, a seat control method may comprise: monitoring a collision occurrence signal that indicates a vehicle collision has occurred; generating, based on the monitoring, one of an automatic mode seat operation request command or a manual mode seat operation request command; and based on the automatic mode seat operation request command and the collision occurrence signal, determining whether to drive one or more seat motors. The determining whether to drive the one or more seat motors may include deactivating, based on the collision occurrence signal, driving of the one or more seat motors. The determining whether to drive the one or more seat motors further may include activating, based on a termination of the collision occurrence signal, driving of the one or more seat motors. The seat control method may further comprises, based on the manual mode seat operation request command, driving the one or more seat motors to control a seat of a vehicle, regardless of the collision occurrence signal.

### BRIEF DESCRIPTION OF THE DRAWINGS

FIG. 1 shows an example of a seat control apparatus.

FIG. 2 and FIG. 3 show examples of the seat control apparatus.

FIG. 4 shows an example of an operation example of a seat.

FIG. 5 shows an example of a seat control method.

FIG. 6 shows an example of a seat control method.

FIG. 7 shows an example of a seat control apparatus.

FIG. 8 shows an example of a computing device for implementing the seat control apparatus and the seat control method.

### DETAILED DESCRIPTION

The present invention will be described more fully hereinafter with reference to the accompanying drawings, in which examples of the invention are shown. As those skilled in the art would realize, the described examples may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various constituent elements, but the constituent elements are not limited by the terms. The terms are used only to discriminate one constituent element from another constituent element.

In addition, the terms “˜ unit”, “ . . . or”, and “module” described in the specification mean units for processing at least one function and operation and can be implemented by hardware components or software components and combinations thereof. In addition, at least some of the configurations or functions of a seat control apparatus and a seat control method according to the examples described below may be implemented as programs or software, and the programs or software may be stored on a computer-readable medium.

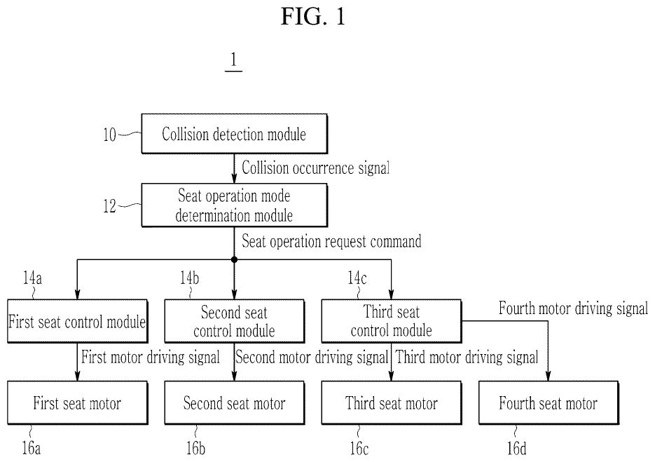

FIG. 1 shows an example of a seat control apparatus.

Referring to FIG. 1, a seat control apparatus 1 may include a collision detection module 10, a seat operation mode determination module 12, a plurality of seat control modules 14a, 14b, and 14c, and a plurality of seat motors 16a, 16b, 16c, and 16d.

The collision detection module 10 may detect a collision of the vehicle and output a collision occurrence signal if a collision has occurred. The collision detection module 10 may include a safety controller, such as a collision detection sensor, a collision detection controller, an Airbag Control Unit (ACU), and a belt controller. The collision occurrence signal output from the collision detection module 10 may be transmitted to the seat operating mode determination module 12 through hard wire, a Controller Area Network (CAN) bus, a Local Interconnect Network (LIN), or the like.

The seat operation mode determination module 12 may determine a seat operation mode of the vehicle, between an automatic mode and a manual mode, and output a seat operation request command, including an automatic mode seat operation request command or a manual mode seat operation request command. Here, the automatic mode seat operation request command may be a command that, once a button is recognized as being pressed, requests that a predetermined seat operation be completed to the end, regardless of whether the button is still pressed, and the manual mode seat operation request command may be a command that requests a manual adjustment to operate the seat only while the button is pressed. The seat operation mode determination module 12 may include a seat switch controller or a domain controller. The seat operation request command output from the seat operation mode determination module 12 may be transmitted to the plurality of seat control modules 14a, 14b, and 14c through hardwire, the CAN bus, the LIN, and the like.

The seat operation mode determination module 12 may determine whether to transmit the seat operation request command based on whether a collision occurrence signal is received from the collision detection module 10. Specifically, if the collision occurrence signal is received from the collision detection module 10, the seat operation mode determination module 12 may deactivate transmission of the automatic mode seat operation request command to the plurality of seat control modules 14a, 14b, and 14c. For example, if the seat operation mode determination module 12 recognizes that a vehicle collision situation exists by receiving the collision occurrence signal, the seat operation mode determination module 12 may not transmit the automatic mode seat operation request command to the plurality of seat control modules 14a, 14b, and 14c. Therefore, it is possible to prevent the seat from operating in the automatic mode even if the one-touch button is pressed in a vehicle collision situation.

On the other hand, if the reception of the collision occurrence signal is terminated, the seat operation mode determination module 12 may activate transmission of the automatic mode seat operation request command to the plurality of seat control modules 14a, 14b, and 14c. For example, the collision occurrence signal may be continued during a dangerous situation caused by a collision, and the reception of the collision occurrence signal may be terminated after the dangerous situation is resolved, if a safe situation is recognized according to the termination of reception of the collision occurrence signal, the seat operation mode determination module 12 may transmit the automatic mode seat operation request command to the plurality of seat control modules 14a, 14b, and 14c, and the seat may be operated in the automatic mode if the one-touch button is pressed.

The plurality of seat control modules 14a, 14b, and 14c may control the seats of the vehicle by driving the plurality of seat motors 16a, 16b, 16c, and 16d in response to the seat operation request command received from the seat operation mode determination module 12. The plurality of seat control modules 14a, 14b, and 14c may include a controller capable of operating the plurality of seat motors 16a, 16b, 16c, and 16d based on the seat operation request command received from the seat switch or the domain controller. In some examples, the plurality of seat control modules 14a, 14b, and 14c may perform controls, such as a motor driving order, based on a motor state or voltage state at the time of the reception of the seat operation request command from the seat operation mode determination module 12. In some examples, the plurality of seat control modules 14a, 14b, and 14c may include a motorized seat control device for moving the seat, as well as a lumbar unit, a massage device, and a cable pull actuator operation relay device for unlocking a seat mechanism.

In some examples, the seat operating mode determination module 12 and the plurality of seat control modules 14a, 14b, and 14c may be reprogrammable or upgradeable during vehicle operation.

The plurality of seat motors 16a, 16b, 16c, and 16d may include at least one of motors to operate seat movements, such as reclining, sliding, height, tilt, leg rest, and headrest, air cells, valves, seat lumbar actuation motors including DC motors, and seat massage motors, including 1-axis reciprocating actuators for striking and oscillating actuators.

The plurality of seat motors 16a, 16b, 16c, and 16d may be positioned at various points of the seat depending on their respective operational purposes, and the same is applied to the plurality of seat control modules 14a, 14b, and 14c driving the plurality of seat motors 16a, 16b, 16c, and 16d. According to the present example, by adopting a structure in which the plurality of seat control modules 14a, 14b, and 14c do not each determine whether the vehicle is in a collision and individually control the motors, and the seat operation mode determination module 12 in a higher layer of the plurality of seat control modules 14a, 14b, and 14c determines whether to operate the seat based on whether the vehicle is in a collision, the development of software and updates after delivery of the vehicle may be made efficient.

In the present example, a first seat control module 14a may drive a first seat motor 16a by using a first motor drive signal, a second seat control module 14b may drive a second seat motor 16b by using a second motor drive signal, and a third seat control module 14c may drive a fourth seat motor 16d by using a fourth motor drive signal while driving a third seat motor 16c by using a third motor drive signal

For example, one seat control module may drive one or more seat motors.

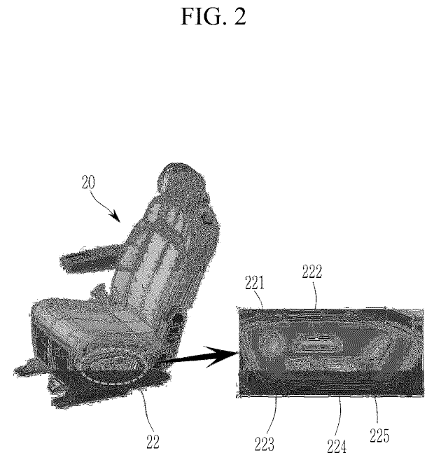

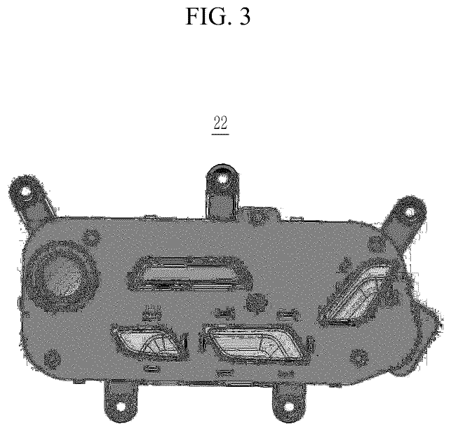

FIGS. 2 and 3 show examples of the seat control apparatus according to the example.

Referring to FIGS. 2 and 3, the seat operation mode determination module 12 of the seat control apparatus according to the example may be implemented as a seat switch controller 22. In some examples, the seat operation mode determination module 12 as the seat switch controller 22 may be implemented to include a button disposed on the cushion portion of the seat 20 and having one-touch function, as illustrated. Specifically, the seat switch controller 22 may include one or more automatic mode buttons 221 and 222 and one or more manual mode buttons 223, 224, and 225.

The one or more automatic mode buttons 221 and 222 may be implemented as auto walk-in switches, auto-relaxation switches, auto-return switches, massage switches, and the like, and after the button is pressed once, the seat operation may continue until the corresponding function is completed. On the other hand, the one or more manual mode buttons 223, 224, and 225 may be implemented to perform functions, such as leg support, cushion extension, slide, cushion angle and height adjustment, backrest angle adjustment, and the like, and the seat operation for the corresponding functions may be performed only while the button is pressed.

The rear surface of the seat switch controller 22 may be equipped with input/output interfaces, such as input/output pins, for transmitting and receiving data or signals to and from other elements, such as the collision detection module 10 and the plurality of seat control modules 14a, 14b, and 14c, through hardwires, the CAN bus, the LIN, and the like.

Of course, the seat operation mode determination module 12 may be disposed in other locations on the vehicle or seat 20 in a different shape from that shown in FIGS. 2 and 3, and the actual implementation form may vary depending on the specific implementation purpose.

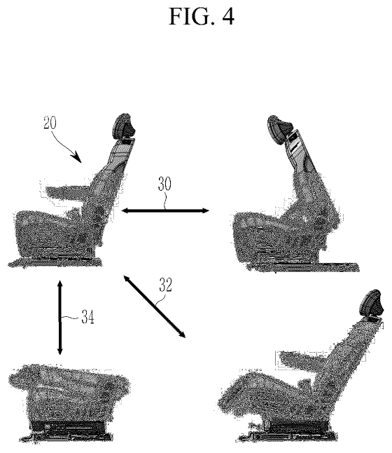

FIG. 4 shows an example of an operation example of a seat.

Referring to FIG. 4, the seat 20 according to the example may perform various operations through user control, which is input through the seat switch controller 22. For example, if the auto walk-in switch is pressed once, the seat 20 may perform an operation 30 to adjust the walk-in, thereby securing a space to facilitate entry and exit of the occupant. As another example, if the auto-relaxation switch is pressed once, the seat 20 may perform an operation 32 to adjust the relaxation, thereby ensuring that the occupant is in a comfortable position. As another example, if the auto-folding switch is pressed once, the seat 20 performs an operation 34 to adjust the folding, thereby implementing a full-flat position for cargo storage. As another example, if the massage switch is pressed once, the seat 20 may also perform an operation 34 to provide a massage to the occupant.

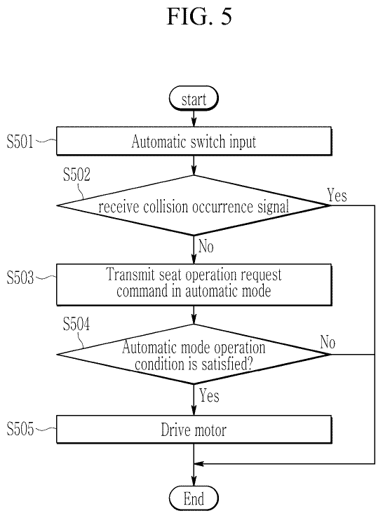

FIG. 5 shows an example of a seat control method.

Referring to FIG. 5, a seat control method may include operation S501 of receiving an operation switch (or operation button) as input to initiate an operation of an automatic mode, and operation S502 of determining whether a collision occurrence signal is received. The operation S502 may be performed by determining whether a collision occurrence signal output from the collision detection module 10 is received.

If it is determined that the collision occurrence signal is received (S502, YES), a seat operation may not be performed. Specifically, the seat operation mode determination module 12 may not perform the seat operation by not transmitting an automatic mode seat operation request command to the seat control modules 14a, 14b, and 14c that drive the seat motors 16a, 16b, 16c, and 16d.

If it is determined that the collision occurrence signal is not received (S502, NO), an automatic mode seat operation request command may be transmitted in operation S503. Specifically, the seat operation mode determination module 12 may transmit the automatic mode seat operation request command to the seat control modules 14a, 14b, and 14c that drive the seat motors 16a, 16b, 16c, and 16d.

In operation S504, if the seat control modules 14a, 14b, and 14c receive the automatic mode seat operation request command from the seat operation mode determination module 12, the seat control modules 14a, 14b, and 14c may determine whether an automatic mode operation condition is satisfied. As described above, the seat control modules 14a, 14b, and 14c may correspond to a variety of devices, including a motorized seat control device, a lumbar device, a massage device, a cable pull actuator operation relay device for unlocking the seat mechanism, and the like, each of which may have its unique automatic mode operation condition. If the seat control modules 14a, 14b, and 14c determine that the automatic mode operating condition is satisfied (S504, YES), in operation S505, the seat control modules 14a, 14b, and 14c may drive the seat motors 16a, 16b, 16c, and 16d to control the seats of the vehicle. Alternatively or additionally, if it is determined that the automatic mode operation condition is not satisfied (S504, NO), the seat control module 14a, 14b, and 14c may not drive the seat motors 16a, 16b, 16c, and 16d and not perform seat operation.

In the present example, the seat operation mode determination module 12 may transmit a manual mode seat operation request command to the seat control modules 14a, 14b, 14c regardless of whether a collision occurrence signal is received. If the seat control modules 14a, 14b, and 14c receive a manual mode seat operation request command from the seat operation mode determination module 12, the seat control modules 14a, 14b, and 14c may determine whether a manual mode operation condition is satisfied. If it is determined that the manual mode operating condition is satisfied, the seat control modules 14a, 14b, and 14c may drive the seat motors 16a, 16b, 16c, and 16d to control the seat, and if it is determined that the manual mode operating condition is not satisfied, the seat control modules 14a, 14b, and 14c may not drive the seat motors 16a, 16b, 16c, 16d and not perform seat operation.

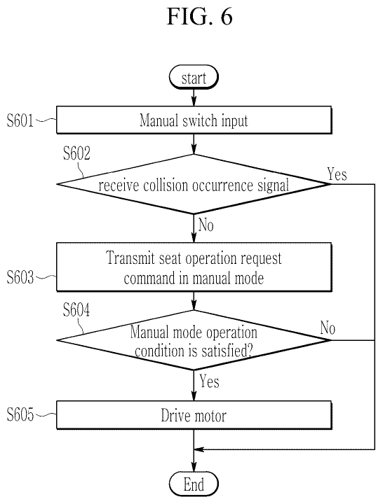

FIG. 6 shows an example of a seat control method.

Referring to FIG. 6, the seat control method according to the example may be the same as the example described above with reference to FIG. 5 in that, in the case of the automatic mode, whether to operate the seat is determined based on whether a collision occurrence signal is received, but may differ from the example described above with reference to FIG. 5 in that, in the case of the manual mode, whether to operate the seat is determined based on whether a collision occurrence signal is received. Specifically, the method may include operation S601 of receiving an operation switch (or operation button) to initiate an operation of a manual mode as input, and operation S602 of determining whether a collision occurrence signal is received. The operation S602 may be performed by determining whether a collision occurrence signal output from the collision detection module 10 is received.

If it is determined that the collision occurrence signal is received (S602, YES), a seat operation may not be performed. Specifically, the seat operation mode determination module 12 may not perform the seat operation by not transmitting a manual mode seat operation request command to the seat control modules 14a, 14b, and 14c that drive the seat motors 16a, 16b, 16c, and 16d.

If it is determined that the collision occurrence signal is not received (S602, NO), a seat operation request command may be transmitted in the manual mode in operation S603. Specifically, the seat operation mode determination module 12 may transmit the manual mode seat operation request command to the seat control modules 14a, 14b, and 14c that drive the seat motors 16a, 16b, 16c, and 16d.

In operation S604, if the seat control modules 14a, 14b, and 14c receive the manual mode seat operation request command from the seat operation mode determination module 12, the seat control modules 14a, 14b, and 14c may determine whether a unique manual mode operation conditions of each of the seat control modules 14a, 14b, and 14c is satisfied. If the seat control modules 14a, 14b, and 14c determine that the manual mode operating condition is satisfied (YES), in operation S605, the seat control modules 14a, 14b, and 14c may drive the seat motors 16a, 16b, 16c, and 16d to control the seats of the vehicle. Alternatively or additionally, if it is determined that the manual mode operation condition is not satisfied (S604, NO), the seat control module 14a, 14b, and 14c may not drive the seat motors 16a, 16b, 16c, and 16d and not perform seat operation.

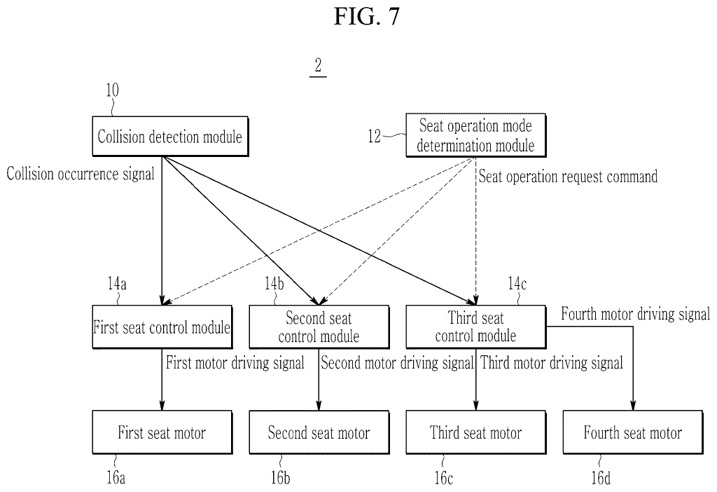

FIG. 7 shows an example of a seat control apparatus.

Referring to FIG. 7, a seat control apparatus 2 may include a collision detection module 10, a seat operation mode determination module 12, a plurality of seat control modules 14a, 14b, and 14c, and a plurality of seat motors 16a, 16b, 16c, and 16d.

The collision detection module 10 may detect a collision of the vehicle and output a collision occurrence signal if a collision has occurred. Reference may be made to the foregoing description with reference to FIG. 1 for details of the collision detection module 10, except that the collision detection module 10 transmits a collision occurrence signal to the plurality of seat control modules 14a, 14b, and 14c.

The seat operation mode determination module 12 may determine a seat operation mode of the vehicle, between an automatic mode and a manual mode, and output a seat operation request command, including an automatic mode seat operation request command or a manual mode seat operation request command. For further details of the seat operation mode determination module 12, reference may be made to the foregoing description with reference to FIG. 1.

The plurality of seat control modules 14a, 14b, and 14c may determine whether to drive the plurality of seat motors 16a, 16b, 16c, and 16d based on receipt of a collision occurrence signal and a seat operation request command. Specifically, the plurality of seat control modules 14a, 14b, 14c may deactivate driving of the plurality of seat motors 16a, 16b, 16c, 16d if an automatic mode seat operation request command is received from the seat operation mode determination module 12 and a collision occurrence signal is received from the collision detection module 10. On the other hand, if the reception of a collision occurrence signal from the collision detection module 10 is terminated, the plurality of seat control modules 14a, 14b, and 14c may activate driving of the plurality of seat motors 16a, 16b, 16c, and 16d in response to the automatic mode seat operation request command. With this exception, reference may be made to the foregoing description with reference to FIG. 1 for details of the plurality of seat control modules 14a, 14b, and 14c and the plurality of seat motors 16a, 16b, 16c, and 16d.

In the present example, a first seat control module 14a may drive a first seat motor 16a by using a first motor drive signal, a second seat control module 14b may drive a second seat motor 16b by using a second motor drive signal, and a third seat control module 14c may drive a fourth seat motor 16d by using a fourth motor drive signal while driving a third seat motor 16c by using a third motor drive signal

For example, one seat control module may drive one or more seat motors.

In the present example, if the automatic mode seat operation request command is received from the seat operation mode determination module 12, the plurality of seat control modules 14a, 14b, and 14c may determine whether an automatic mode operation condition is satisfied, and, if the automatic mode operation condition is determined to be satisfied, the plurality of seat control modules 14a, 14b, and 14c may drive the plurality of seat motors 16a, 16b, 16c, and 16d to control the seats of the vehicle. Alternatively or additionally, if it is determined that the automatic mode operation condition is not satisfied, the plurality of seat control modules 14a, 14b, and 14c may not drive the seat motors 16a, 16b, 16c, and 16d.

In the present example, if a manual mode seat operation request command is received from the seat operation mode determination module 12, the plurality of seat control modules 14a, 14b, and 14c may control the seats of the vehicle by driving the plurality of seat motors 16a, 16b, 16c, and 16d regardless of whether a collision occurrence signal is received. If the manual mode seat operation request command is received from the seat operation mode determination module 12, the plurality of seat control modules 14a, 14b, 14c may determine whether the manual mode operation condition is satisfied, and, if it is determined that the manual mode operation condition is satisfied, the plurality of seat control modules 14a, 14b, 14c may drive the plurality of seat motors 16a, 16b, 16c, and 16d to control the seats of the vehicle. Alternatively or additionally, if it is determined that the manual mode operation condition is not satisfied, the plurality of seat control modules 14a, 14b, and 14c may not drive the plurality of seat motors 16a, 16b, 16c, and 16d.

In some other examples, the plurality of seat control modules 14a, 14b, and 14c may determine whether to operate a seat based on receipt of a collision occurrence signal, even in the manual mode.

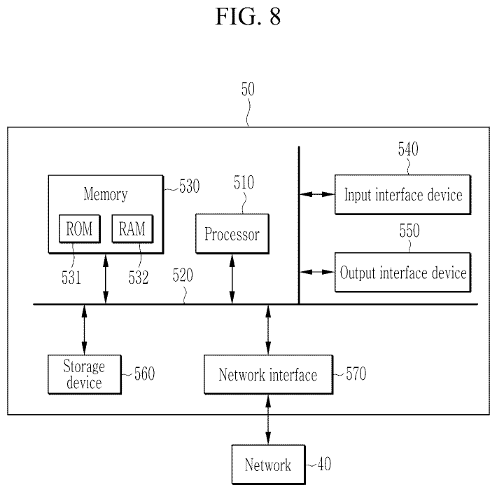

FIG. 8 shows an example of a computing device for implementing the seat control apparatus and the seat control method.

Referring now to FIG. 8, the seat control apparatus and the seat control method may be implemented by using a computing device 50.

The computing device 50 may include at least one of a processor 510, a memory 530, a user interface input device 540, a user interface output device 550, and a storage device 560 communicating through a bus 520. The computing device 50 may also include a network interface 570 that electrically connects to the network 40. The network interface 570 may transmit or receive a signal with another entity through the network 40.

The processor 510 may be implemented in various types, such as a Micro Controller Unit (MCU), an Application Processor (AP), a Central Processing Unit (CPU), a Graphic Processing Unit (GPU), and the like, and may be a predetermined semiconductor device executing commands stored in the memory 530 or the storage device 560. The processor 510 may be configured to implement the function and the methods described above with reference to FIGS. 1 to 7.

The memory 530 and the storage device 560 may include various types of volatile or non-volatile storage media. For example, the memory may include a Read Only Memory (ROM) 531 and a Random Access Memory (RAM) 532. In the example, the memory 530 may be located inside or outside the processor 510, and the memory 530 may be connected with the processor 510 through already known various means.

In some examples, at least some configurations or functions of the seat control apparatus and the seat control method may be implemented as programs or software executed on the computing device 50, and the programs or software may be stored on a computer-readable medium.

In some examples, at least some configurations or functions of the seat control apparatus and the seat control method may be implemented in hardware that is electrically coupled to the computing device 50.

The present disclosure attempts to provide an apparatus and a method of controlling a seat, which are capable of preventing malfunction of a seat by deactivating a one-touch function of the seat in an accident situation including a vehicle collision.

An example provides a seat control apparatus including: a collision detection module for detecting a collision of a vehicle, and outputting a collision occurrence signal if a collision has occurred; a seat operation mode determination module for determining a seat operation mode of the vehicle between an automatic mode and a manual mode and outputting a seat operation request command including an automatic mode seat operation request command or a manual mode seat operation request command, and determining whether to transmit the seat operation request command based on whether the collision occurrence signal is received; and a seat control module for driving one or more seat motors according to the seat operation request command and controlling a seat of the vehicle.

In some examples, if the collision occurrence signal is received, the seat operation mode determination module may deactivate transmission of the automatic mode seat operation request command to the seat control module.

In some examples, if the reception of the collision occurrence signal is terminated, the seat operation mode determination module may activate transmission of the automatic mode seat operation request command to the seat control module.

In some examples, if the automatic mode seat operation request command is received from the seat operation mode determining module, the seat control module may determine whether an automatic mode operation condition is satisfied, and if it is determined that the automatic mode operation condition is satisfied, the seat control module may drive the one or more seat motors to control the seat.

In some examples, if it is determined that the automatic mode operation condition is not satisfied, the seat control module does not drive the one or more seat motors.

In some examples, the seat operation mode determination module may transmit the manual mode seat operation request command to the seat control module regardless of whether the collision occurrence signal is received.

In some examples, if the manual mode seat operation request command is received from the seat operation mode determining module, the seat control module may determine whether a manual mode operation condition is satisfied, and if it is determined that the manual mode operation condition is satisfied, the seat control module may drive the one or more seat motors to control the seat.

In some examples, if it is determined that the manual mode operation condition is not satisfied, the seat control module may not drive the one or more seat motors.

Another example provides a seat control apparatus including: a collision detection module for detecting a collision of a vehicle, and outputting a collision occurrence signal if a collision has occurred; a seat operation mode determination module for determining a seat operation mode of the vehicle between an automatic mode and a manual mode, and outputting a seat operation request command including an automatic mode seat operation request command or a manual mode seat operation request command; and a seat control module for determining whether to drive one or more seat motors in response to whether the collision occurrence signal has been received and the seat operation request command.

In some examples, if an automatic mode seat operation request command is received from the seat operation mode determination module, and the collision occurrence signal is received from the collision detection module, the seat control module may deactivate driving of the one or more seat motors.

In some examples, if the reception of the collision occurrence signal is terminated, the seat control module may activate driving of the one or more seat motors according to the automatic mode seat operation request command.

In some examples, if the automatic mode seat operation request command is received from the seat operation mode determining module, the seat control module may determine whether the automatic mode operation condition is satisfied, and if it is determined that the automatic mode operation condition is satisfied, the seat control module may drive the one or more seat motors to control the seat.

In some examples, if it is determined that the automatic mode operation condition is not satisfied, the seat control module may not drive the one or more seat motors.

In some examples, if a manual mode seat operation request command is received from the seat operation mode determination module, the seat control module may drive the one or more seat motors to control a seat of the vehicle regardless of whether the collision occurrence signal has been received.

In some examples, if the manual mode seat operation request command is received from the seat operation mode determining module, the seat control module may determine whether a manual mode operation condition is satisfied, and if it is determined that the manual mode operation condition is satisfied, the seat control module may drive the one or more seat motors to control the seat of the vehicle.

In some examples, if it is determined that the manual mode operation condition is not satisfied, the seat control module may not drive the one or more seat motors.

Still another example provides a seat control method including: monitoring a collision occurrence signal that indicates a vehicle collision has occurred; receiving a seat operation request command including an automatic mode seat operation request command or a manual mode seat operation request command; and if the automatic mode seat operation request command is received, determining whether to drive one or more seat motors based on presence of the collision occurrence signal.

In some examples, the determining of whether to drive the seat motor may include deactivating the driving of the one or more seat motors if the collision occurrence signal is received.

In some examples, the determining of whether to drive the seat motor may further include activating the driving of the one or more seat motors if the reception of the collision occurrence signal is terminated.

In some examples, the seat control method may further include, if the manual mode seat operation request command is received, driving the one or more seat motors to drive a seat of the vehicle, regardless of the presence or absence of the collision occurrence signal.

According to the examples described so far, it is possible to recognize an accident situation including a vehicle collision, and deactivating the one-touch function of a seat, thereby preventing a personal accident that may occur due to a malfunction of the seat according to the pressing of a button having a one-touch function due to deformation of an internal component in an accident, and promoting safety of the occupants.

According to the examples described so far, it is possible to recognize an accident situation including a vehicle collision, and deactivate the one-touch function of a seat, thereby preventing a personal accident that may occur due to a malfunction of the seat according to the pressing of a button having a one-touch function due to deformation of an internal component in an accident, and promoting safety of the occupants.

Although the above examples of the present invention have been described in detail, the scope of the present invention is not limited thereto, but also includes various modifications and improvements by one of ordinary skill in the art utilizing the basic concepts of the present invention as defined in the following claims.

What is claimed is:

1. A seat control apparatus comprising:
one or more processors; and
memory storing instructions that, when executed by the one or more processors, cause the seat control apparatus to:
detect a collision of a vehicle;
output, based on the detection, a collision occurrence signal;
determine a seat operation mode of the vehicle between an automatic mode and a manual mode;
output, based on the determination, one of an automatic mode seat operation request command or a manual mode seat operation request command;
determine, based on the collision occurrence signal, whether to transmit one of the automatic mode seat operation request command or the manual mode seat operation request command; and
drive, based on the one of the automatic mode seat operation request command or the manual mode seat operation request command, one or more seat motors to control a seat of the vehicle.

2. The seat control apparatus of claim 1, wherein the instructions, when executed by the one or more processors, further cause the seat control apparatus to deactivate, based on the collision occurrence signal, transmission of the automatic mode seat operation request command.

3. The seat control apparatus of claim 2, wherein the instructions, when executed by the one or more processors, further cause the seat control apparatus to activate, based on a termination of the collision occurrence signal, transmission of the automatic mode seat operation request command.

4. The seat control apparatus of claim 3, wherein the instructions, when executed by the one or more processors, further cause the seat control apparatus to:
determine, based on the automatic mode seat operation request command, whether an automatic mode operation condition is satisfied; and
based on a determination that the automatic mode operation condition is satisfied, drive the one or more seat motors to control the seat.

5. The seat control apparatus of claim 4, wherein the instructions, when executed by the one or more processors, further cause the seat control apparatus not to drive, based on a determination that the automatic mode operation condition is not satisfied, the one or more seat motors.

6. The seat control apparatus of claim 1, wherein the instructions, when executed by the one or more processors, further cause the seat control apparatus to transmit the manual mode seat operation request command regardless of whether the collision occurrence signal is outputted.

7. The seat control apparatus of claim 6, wherein the instructions, when executed by the one or more processors, further cause the seat control apparatus to:
determine, based on the manual mode seat operation request command, whether a manual mode operation condition is satisfied; and
based on a determination that the manual mode operation condition is satisfied, drive the one or more seat motors to control the seat.

8. The seat control apparatus of claim 7, wherein the instructions, when executed by the one or more processors, further cause the seat control apparatus not to drive, based on a determination that the manual mode operation condition is not satisfied, the one or more seat motors.

9. A seat control apparatus comprising:
one or more processors; and
memory storing instructions that, when executed by the one or more processors, cause the seat control apparatus to: detect a collision of a vehicle; output, based on the detection, a collision occurrence signal;
determine a seat operation mode of the vehicle between an automatic mode and a manual mode;
output one of an automatic mode seat operation request command or a manual mode seat operation request command; and
determine, based on the collision occurrence signal and the one of the automatic mode seat operation request command or the manual mode seat operation request command, whether to drive one or more seat motors.

10. The seat control apparatus of claim 9, wherein the instructions, when executed by the one or more processors, further cause the seat control apparatus to deactivate, based on the automatic mode seat operation request command and the collision occurrence signal, driving of the one or more seat motors.

11. The seat control apparatus of claim 10, wherein the instructions, when executed by the one or more processors, further cause the seat control apparatus to activate, based on the automatic mode seat operation request command and a termination of the collision occurrence signal, driving of the one or more seat motors.

12. The seat control apparatus of claim 11, wherein the instructions, when executed by the one or more processors, further cause the seat control apparatus to:
determine, based on the automatic mode seat operation request command, whether an automatic mode operation condition is satisfied; and
based on a determination that the automatic mode operation condition is satisfied, drive the one or more seat motors to control a seat of the vehicle.

13. The seat control apparatus of claim 12, wherein the instructions, when executed by the one or more processors, further cause the seat control apparatus not to drive, based on a determination that the automatic mode operation condition is not satisfied, the one or more seat motors.

14. The seat control apparatus of claim 9, wherein the instructions, when executed by the one or more processors, further cause the seat control apparatus to drive, based on the manual mode seat operation request command, the one or more seat motors to control a seat of the vehicle regardless of whether the collision occurrence signal has been received.

15. The seat control apparatus of claim 14, wherein the instructions, when executed by the one or more processors, further cause the seat control apparatus to:
determine, based on the manual mode seat operation request command, whether a manual mode operation condition is satisfied; and
based on a determination that the manual mode operation condition is satisfied, drive the one or more seat motors to control the seat of the vehicle.

16. The seat control apparatus of claim 15, wherein the instructions, when executed by the one or more processors, further cause the seat control apparatus not to drive, based on a determination that the manual mode operation condition is not satisfied, the one or more seat motors.

17. A seat control method comprising:
monitoring a collision occurrence signal that indicates a vehicle collision has occurred;
generating, based on the monitoring, one of an automatic mode seat operation request command or a manual mode seat operation request command; and
based on the automatic mode seat operation request command and the collision occurrence signal, determining whether to drive one or more seat motors.

18. The seat control method of claim 17, wherein the determining whether to drive the one or more seat motors includes deactivating, based on the collision occurrence signal, driving of the one or more seat motors.

19. The seat control method of claim 18, wherein the determining whether to drive the one or more seat motors further includes activating, based on a termination of the collision occurrence signal, driving of the one or more seat motors.

20. The seat control method of claim 17, further comprising:
based on the manual mode seat operation request command, driving the one or more seat motors to control a seat of a vehicle, regardless of the collision occurrence signal.
